(19) United States
(12) Patent Application Publication
(10) Pub. No.: US 2023/0056489 A1
(43) Pub. Date: Feb. 23, 2023

(54) LEARNING DEVICE, LEARNING METHOD, RECORDING MEDIUM, AND RADAR DEVICE

(71) Applicant: NEC Corporation, Minato-ku, Tokyo (JP)

(72) Inventors: Takashi SHIBATA, Tokyo (JP); Motoki Masaka, Tokyo (JP); Yuichi Abe, Tokyo (JP); Kentarou Kudou, Tokyo (JP); Masanori Kato, Tokyo (JP); Shohei Ikeda, Tokyo (JP)

(73) Assignee: NEC Corporation, Minato-ku, Tokyo (JP)

(21) Appl. No.: 17/797,607

(22) PCT Filed: Feb. 14, 2020
(86) PCT No.: PCT/JP2020/005805

§ 371 Date: Aug. 4, 2022

(51) Int. Cl. G01S 13/95; G06K 9/62

(52) U.S. Cl. CPC G01S 13/95; G06K 9/6256

(57) ABSTRACT

The learning device includes an acquisition unit, a learning data generation unit, and a learning processing unit. The acquisition unit acquires operation data generated during an operation of a radar device and the operation history data indicating operations performed by an operator on the radar device from the radar device. The learning data generation unit generates the learning data using the operation data and the operation history data. The learning processing unit learns an operation determination model that determines an operation to be performed on the radar device based on the operation data, using the learning data.

### TECHNICAL FIELD

The present invention relates to a monitoring technique using a radar.

### BACKGROUND ART

There is known a technique for monitoring a moving object such as an aircraft using radar. Patent Document 1 discloses a method for monitoring a moving target such as an aircraft or a vehicle by a radar device.

### PRECEDING TECHNICAL REFERENCES

### Patent Document

Patent Document 1: Japanese Patent Application Laid-Open under No. 2016-151416

### SUMMARY

### Problem to be Solved by the Invention

The operator of the radar device performs various operations according to the situation. However, even in the same situation, the operation performed by each operator may be different due to the difference in experience and judgment ability. Therefore, it is required to equalize and stabilize the operations performed by the operators.

One object of the present invention is to equalize and stabilize the operations performed by the operators by utilizing machine learning.

### Means for Solving the Problem

According to an example aspect of the present invention, there is provided a learning device comprising:

an acquisition unit configured to acquire, from a radar device, operation data generated during an operation of the radar device and operation history data indicating operations performed by an operator on the radar device;

a learning data generation unit configured to generate learning data using the operation data and the operation history data; and

a learning processing unit configured to learn, using the learning data, an operation determination model which determines an operation to be performed on the radar device based on the operation data.

According to another example aspect of the present invention, there is provided a learning method comprising:

acquiring, from a radar device, operation data generated during an operation of the radar device and operation history data indicating operations performed by an operator on the radar device;

generating learning data using the operation data and the operation history data; and

learning, using the learning data, an operation determination model which determines an operation to be performed on the radar device based on the operation data.

According to still another example aspect of the present invention, there is provided a recording medium recording a program, the program causing a computer to execute processing of:

acquiring, from a radar device, operation data generated during an operation of the radar device and operation history data indicating operations performed by an operator on the radar device;

generating learning data using the operation data and the operation history data; and

learning, using the learning data, an operation determination model which determines an operation to be performed on the radar device based on the operation data.

According to still another example aspect of the present invention, there is provided a radar device comprising:

an acquisition unit configured to acquire operation data generated during an operation; and

an operation determination unit configured to determine an operation to be performed on the radar device based on the operation data acquired by the acquisition unit using a learned operation determination model, the learned operation determination model being learned using the operation data and operation history data indicating operations performed by an operator on the radar device.

### Effect of the Invention

According to the present invention, it is possible to equalize and stabilize the operations performed by the operators by utilizing machine learning.

### BRIEF DESCRIPTION OF THE DRAWINGS

FIG. 1 illustrates a basic configuration of a radar device.

FIG. 2 illustrates a configuration of a signal processing unit.

FIG. 3 is a block diagram illustrating a functional configuration of a learning device.

FIG. 4 illustrates a hardware configuration of a learning device.

FIG. 5 is a flowchart of learning processing by the learning device.

FIG. 6 illustrates a configuration of the radar device to which a learned model is applied.

FIG. 7 is a flowchart of automatic operation processing by the radar device.

FIG. 8 is a block diagram illustrating a functional configuration of a modified example of the learning device.

FIG. 9 illustrates a configuration for performing a beam control for collecting learning data.

FIG. 10 illustrates a configuration for performing on-line learning.

FIG. 11 illustrates a configuration for evaluating validity of a learned model.

FIG. 12 illustrates a configuration for suppressing operation fluctuation by a learned model.

FIGS. 13A and 13B illustrate configurations of a learning device and a radar device according to a second example embodiment.

### EXAMPLE EMBODIMENTS

Preferred example embodiments of the present invention will be described with reference to the accompanying drawings. The radar device in the example embodiments can be used in a monitoring system of moving objects present in the surroundings. Specifically, the radar device detects a moving object (hereinafter, also referred to as a “target”) by emitting transmission waves to the surroundings and receiving the reflected waves thereof, and tracks the target if necessary. Targets include, for example, aircrafts flying in the air, vehicles traveling on the ground, and ships traveling over the sea. In the following example embodiments, for convenience of description, it is supposed that radar device is used for air traffic control and the target is primarily an aircraft.

<Basic Configuration of Radar Device>

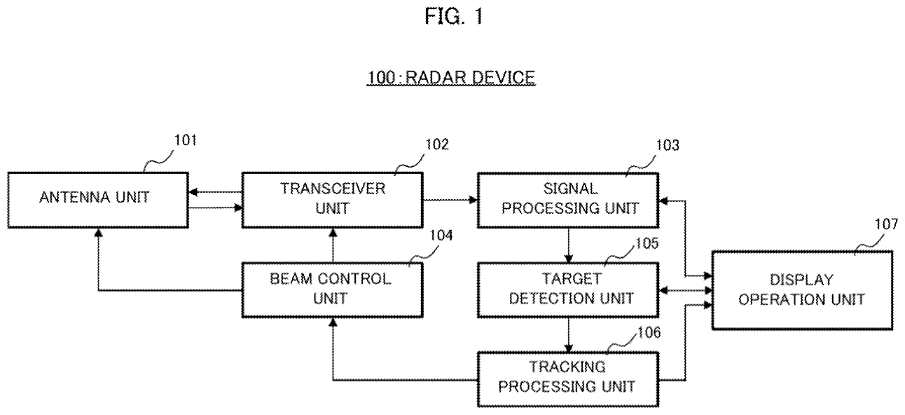

First, the basic configuration of the radar device will be described. FIG. 1 is a block diagram showing a basic configuration of a radar device. The radar device 100 includes an antenna unit 101, a transceiver unit 102, a signal processing unit 103, a beam control unit 104, a target detection unit 105, a tracking processing unit 106, and a display operation unit 107.

The antenna unit 101 amplifies an electric signal inputted from the transceiver unit 102 (hereinafter, also referred to as “transmission signal”), and emits a transmission wave (referred to as “beam”) in the transmission direction instructed by the beam control unit 104. Also, the antenna unit 101 converts the reflected wave of the emitted transmission wave reflected by the target to an electric signal (hereinafter, also referred to as “reception signal”), synthesizes the electric signals and outputs a synthesized signal to the transceiver unit 102.

In this example embodiment, the radar device 100 emits a beam (referred to as a “scan beam”) that constantly scans all directions (ambient 360°) to monitor the presence of a target in the surroundings. Also, if a target is detected, the radar device 100 emits a beam (referred to as a “tracking beam”) to track that target and tracks the trajectory of the target (referred to as a “track”). From this point, the antenna unit 101 is constituted by an antenna capable of changing the transmission direction instantaneously, such as an array antenna comprising a plurality of antenna elements. Specifically, a plurality of planar array antennas may be arranged to cover all directions, or a cylindrical array antenna may be used. Thus, it is possible to emit the tracking beam in the direction of the target when the target is detected, while constantly emitting the scan beam in all directions.

The transceiver unit 102 generates the electric signal based on the transmission wave specification instructed by the beam control unit 104 (hereinafter, also referred to as beam specification), and outputs the electric signal to the antenna unit 101. The beam specification includes the pulse width of the transmission wave, the transmission timing, and the like. Also, the transceiver unit 102 A/D-converts the reception signal inputted from the antenna unit 101, removes the unnecessary frequency band therefrom, and outputs it to the signal processing unit 103 as a reception signal.

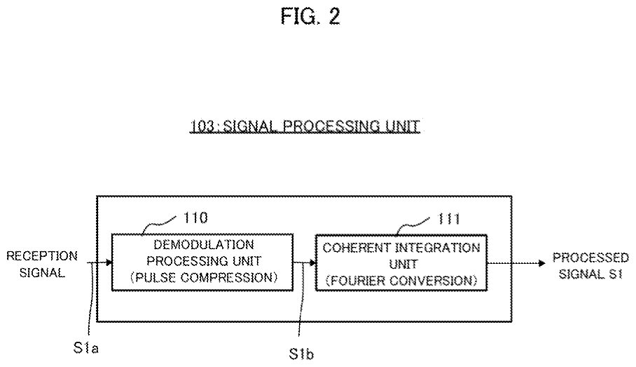

The signal processing unit 103 applies demodulation processing and integration processing to the reception signal inputted from the transceiver unit 102, and outputs the reception signal after the processing (hereinafter, also referred to as “processed signal”) to the target detection unit 105. FIG. 2 is a block diagram showing a configuration of the signal processing unit 103. The signal processing unit 103 includes a demodulation processing unit 110, and a coherent integration unit 111. The demodulation processing unit 110 demodulates (performs pulse compression of) the reception signal inputted from the transceiver unit 102. Essentially, sharp transmission waves (transmission pulses) with high power are required to detect distant targets by radar, but there is a limit to power enhancement due to constraints such as hardware. Therefore, at the time of emitting the beam, the transceiver unit 102 generates the transmission waves of long duration by frequency-modulating the transmission signals having a predetermined pulse width, and transmits them from the antenna unit 101. Correspondingly, the demodulation processing unit 110 demodulates the reception signal inputted from the transceiver unit 102 to generate the sharp reception pulses, and outputs them to the coherent integration unit 111.

The coherent integration unit 111 removes noise by coherently integrating the plural pulses inputted from the demodulation processing unit 110, thereby to improve the SNR. The radar device 100 emits a plurality of pulses in the same direction (in the same azimuth and the same elevation angle) in order to detect the target with high accuracy. The number of pulses emitted in the same direction is called “hit number”. The coherent integration unit 111 integrates the reception signal (the reception pulses) of the beam of a predetermined hit number emitted in the same direction, and thereby improves the SNR of the reception signal. Incidentally, the number of the reception pulses integrated by the coherent integration unit 111 is also referred to as “integration pulse number”. The integration pulse number is basically equal to the hit number of the emitted beam.

Returning to FIG. 1, the target detection unit 105 detects the target from the processed signal inputted from the signal processing unit 103 using a predetermined threshold. The target detection unit 105 measures the distance, the azimuth, and the elevation of the target, and outputs them as the target detection result (hereinafter, referred to as “plot”) to the tracking processing unit 106. The plot includes the distance, the azimuth, the elevation, the SNR of the target. Further, the target detection unit 105 sets the threshold value for detecting the target, based on the threshold setting value inputted from the display operation unit 107.

The tracking processing unit 106 performs tracking processing for a plurality of plots inputted from the target detection unit 105 and calculates the track of the target. Specifically, the tracking processing unit 106 predicts the position of the target at the current time (referred to as “estimated target position”) based on the plurality of plots, and outputs it to the display operation unit 107. Further, the tracking processing unit 106 calculates the predicted position of the target (referred to as “predicted target position”) based on the plurality of plots and outputs it to the beam control unit 104. The predicted target position indicates the position where the radar device 100 irradiates the tracking beam next.

The beam control unit 104 determines the transmission direction and the beam specification of the scan beam according to a preset beam schedule. Further, the beam control unit 104 determines the transmission direction and the beam specification of the tracking beam based on the predicted target position inputted from the tracking processing unit 106. Then, the beam control unit 104 outputs the transmission directions of the scan beam and the tracking beam to the antenna unit 101, and outputs the beam specification of the scan beam and the tracking beam to the transceiver unit 102.

The display operation unit 107 includes a display unit such as a display, and an operation unit such as a keyboard, a mouse, and operation buttons. The display operation unit 107 displays the positions of the plurality of plots inputted from the target detection unit 105, and the predicted target position inputted from the tracking processing unit 106. This allows the operator to see the current position and/or the track of the detected target. Also, if necessary, the operator operates the display operation unit 107 by himself or herself to make the radar device 100 operate properly (this is also referred to as “manual operation”). Specifically, the following operations are performed by the operator.

(1) Adjusting Threshold

The operator adjusts the threshold that the target detection unit 105 uses for the target detection. When the threshold value is set to be high, the probability of erroneously detecting noise and/or clutter decreases, but the probability of detecting the target is also decreases. On the other hand, when the threshold value is set to be low, the probability of erroneously detecting noise and/or clutter increases, but the probability of detecting the target also increases. Therefore, the operator sets the appropriate threshold value according to the situation. For example, in situations where there is a lot of noise or clutter, the operator sets the threshold higher than usual to prevent the increase of erroneous detection. It is noted that the “clutter” is a signal generated by the reflection of the emitted radar by an object other than the target. The threshold adjusted by the operator is inputted from the display operation unit 107 to the target detection unit 105.

(2) Setting Clutter Area

The operator sets the clutter area in a situation where there is a lot of clutter in the reception signal. The plots detected by the target detection unit 105 are displayed on the display operation unit 107. The operator looks at the plurality of plots displayed on the display operation unit 107 to determine an area that is considered to be clutter in the experience, and operates the display operation unit 107 to designate the clutter area. This is called “setting the clutter area”. The clutter area set by the operator is inputted to the signal processing unit 103. The signal processing unit 103 performs signal processing for removing clutter in the inputted clutter area.

(3) Manual Tracking

When the tracking of the target by the tracking processing unit 106 is difficult or the tracking accuracy is low, the operator performs manual tracking by operating the display operation unit 107. “Manual tracking” means that the operator creates a track by hand and issues a tracking instruction. The instruction of the manual tracking by the operator is inputted to the tracking processing unit 106, and the tracking processing unit 106 performs the tracking processing based on the track created by the operator.

(4) Other Operations

In addition to the above, the operations performed by the operator include switching of the modulation frequency or the transmission frequency of the transmission signal by the transceiver unit 102, switching of the antenna azimuth by the beam control unit 104, changing the operation mode of the radar device 100, switching of the processing system, application of ECCM (Electronic Counter Counter Measure) mode against an electronic attack such as ECM (Electronic Counter Measures), and the like.

With the above configuration, the radar device 100 detects the target by constantly emitting the scan beam in all directions, and emits the tracking beam to the predicted target position to track the target when the target is detected.

### First Example Embodiment

In various situations, the operators perform operations of the radar device by their individual criterion based on their experiences. However, even in the same situation, the operation performed by each operator may be different due to the difference in experience and judgment ability. Therefore, it is required to equalize and stabilize the operations by the operators. In this view, in the present example embodiment, an operation determination model learned by machine learning is applied to the display operation unit 107 to automate a part of the operation performed by the operator.

[Configuration during Learning]

(Overall Configuration)

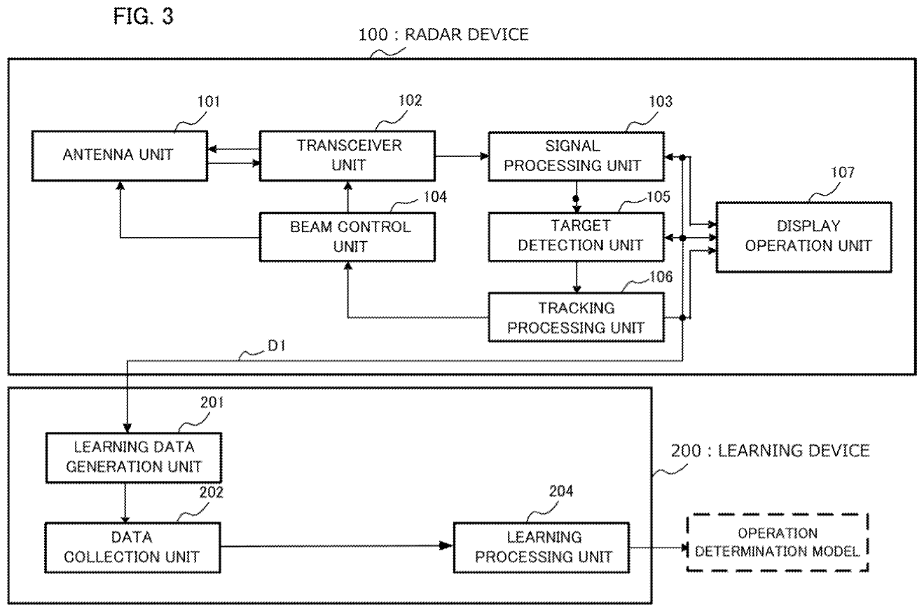

FIG. 3 is a block diagram illustrating a configuration of a radar device at the time of learning an operation determination model. At the time of learning, there is provided a learning device 200 for learning an operation determination model based on the data acquired from the radar device 100. Since the radar device 100 is similar to that shown in FIG. 1, description thereof will be omitted. The learning device 200 includes a learning data generation unit 201, a data collection unit 202, and a learning processing unit 204.

The learning data generation unit 201 acquires judgement material data D1 from the radar device 100. The judgement material data D1 is data that is used as a judgement material when the operator performs the above-described operation. Specifically, the judgement material data D1 is operation data generated by each unit of the radar device 100 during operation, and specifically includes a reception signal outputted by the signal processing unit 103, the plots outputted by the target detection unit 105, the track outputted by the tracking processing unit 106, a state of the radar device 100, and the like. Further, the learning data generation unit 201 acquires the history data (hereinafter, referred to as “operation history data”) D2 of the operations actually performed by the operators from the display operation unit 107.

Then, the learning data generation unit 201 generates the learning data using the judgement material data D1 and the operation history data D2. Specifically, the learning data generation unit 201 generates learning data in which the operations included in the operation history data D2 are used as the teacher labels (correct answer labels) and the judgement material data D1 at that time is used as the input data. For example, in the operation history data D2, if there is a history in which the operator has performed the threshold adjustment of the target detection unit 105, the learning data generation unit 201 generates the learning data in which the reception signal and the plot at that time are used as the input data and the threshold adjustment (including the set threshold value) is used as the teacher label. Then, the learning data generation unit 201 outputs the created learning data to the data collection unit 202.

The data collection unit 202 stores the learning data inputted from the learning data generation unit 201. The data collection unit 202 stores learning data for each operation of the operator included in the operation history data D2, in which the judgement material data at that time and the teacher label indicating the operation are paired. The learning processing unit 204 acquires the learning data from the data collection unit 202 and performs learning of the operation determination model using the acquired learning data. Then, the learning processing unit 204 generates the learned operation determination model.

(Hardware Configuration of Learning Device)

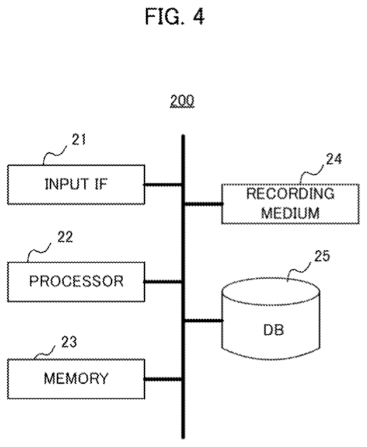

FIG. 4 is a block diagram illustrating a hardware configuration of the learning device 200 illustrated in FIG. 3. As illustrated, the learning device 200 includes an input IF (InterFace) 21, a processor 22, a memory 23, a recording medium 24, and a database (DB) 25.

The input IF 21 inputs and outputs data to and from the radar device 100. Specifically, the input IF 21 acquires the judgement material data D1 and the operation history data D2 from the radar device 100. The processor 22 is a computer including a CPU (Central Processing Unit), a GPU (Graphics Processing Unit), and the like, and controls the entire learning device 200 by executing a program prepared in advance. The processor 22 functions as the learning data generation unit 201 and the learning processing unit 204 shown in FIG. 3.

The memory 23 is composed of ROM (Read Only Memory), RAM (Random Access Memory), and the like. The memory 23 stores various programs to be executed by the processor 22. The memory 23 is also used as a work memory during the execution of various processes by the processor 22.

The recording medium 24 is a non-volatile, non-transitory recording medium such as a disk-shaped recording medium, a semiconductor memory, or the like, and is configured to be detachable from the learning device 200. The recording medium 24 records various programs to be executed by the processor 22. When the learning device 200 performs processing, a program recorded on the recording medium 24 is loaded into the memory 23 and executed by the processor 22.

The DB 25 stores data inputted through the input IF 21 and data generated by the learning device 200. Specifically, the DB 25 stores the judgement material data D1 and the operation history data D2 inputted from the radar device 100, and the learning data generated by the learning data generation unit 201.

(Learning Processing)

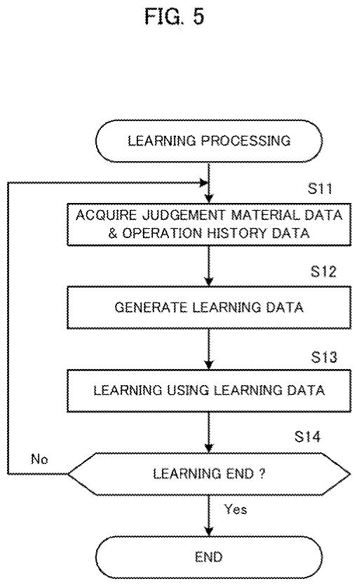

FIG. 5 is a flowchart of the learning processing performed by the learning device 200. This processing can be implemented by the processor 22 shown in FIG. 5, which executes a program prepared in advance and operates as each element shown in FIG. 3.

First, the learning data generation unit 201 acquires the judgement material data D1 and the operation history data D2 from the radar device 100 (Step S11). Next, the learning data generation unit 201 generates the learning data using the judgement material data D1 and the operation history data D2 and stores the learning data in the data collection unit 202 (Step S12). Next, the learning processing unit 204 acquires the learning data from the data collection unit 202 and performs learning of the operation determination model using the learning data (Step S13).

Next, the learning processing unit 204 determines whether or not a predetermined learning end condition is satisfied (step S14). An example of the learning end condition is that learning using a predetermined amount of learning data or learning for a predetermined number of times has been completed. The learning processing unit 204 repeats the learning until the learning end condition is satisfied.

When the learning end condition is satisfied, the processing ends.

[Radar Device to which Operation Determination Model is Applied]

(Configuration)

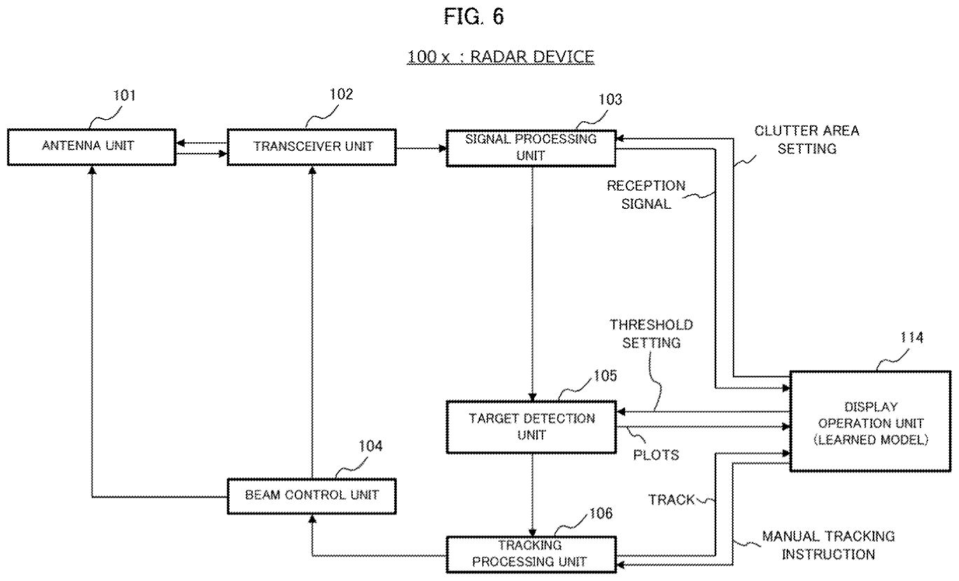

FIG. 6 is a block diagram showing a configuration of a radar device 100x to which a learned operation determination model is applied. As can be seen from comparison with FIG. 1, the radar device 100x includes a display operation unit 114 instead of the display operation unit 107 in FIG. 1. The configuration other than the display operation unit 110 is the same as in FIG. 1.

The learned operation determination model generated by the learning processing described above is set to the display operation unit 114. Further, the judgement material data D1 is inputted to the display operation unit 114. In the example of FIG. 6, as the judgement material data D1, the reception signal is inputted from the signal processing unit 103, the plots are inputted from the target detection unit 105, and the track is inputted from the tracking processing unit 106.

The display operation unit 114 determines the operation based on the inputted judgement material data D1 using the learned operation determination model. Specifically, when the display operation unit 114 determines that the setting of the clutter area is necessary based on the reception signal, the display operation unit 114 sets the clutter area to the signal processing unit 103. When the display operation unit 114 determines that adjustment of the threshold value is necessary based on the reception signal and the plots, the display operation unit 114 sets the threshold value to the target detection unit 105. Further, when the display operation unit 114 determines that manual tracking is necessary based on the track, the display operation unit 114 sets the track to the tracking processing unit 106 and instructs the manual tracking. In this case, the display operation unit 114 functions as an automatic operation unit.

(Automatic Operation Processing)

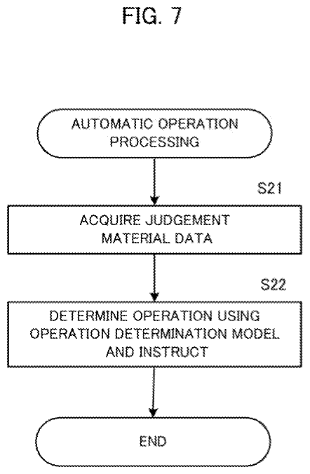

FIG. 7 is a flowchart of automatic operation processing performed by the radar device 100x. First, the display operation unit 114 acquires the judgment material data D1 from each unit of the radar device 100x (step S21). Then, the display operation unit 114 determines an operation to be performed on the radar device 100 from the judgement material data D1 using the learned operation determination model, and instructs the corresponding component in the radar device 100x to perform the operation (step S22).

As described above, in the present example embodiment, since the display operation unit 114 instructs the automatic operation using the operation determination model learned by the machine learning, the influence due to variations in the experience and the determination criteria of the individual operators is reduced, and it becomes possible to stably perform the necessary operation for the radar device.

(Modification)

In the above example, the automatic operation is performed by applying the learned operation determination model to the display operation unit 114. However, in some cases, it is not preferable to completely change the operation to the automatic operation. For example, in the case of the operation in which the operation such as the change of the mode changes greatly, there may be such a risk that the operation is greatly changed by the automatic operation. In such a case, the operation determined by the operation determination model may be recommended to the operator while maintaining the operation by the operator. Specifically, the operation display unit 114 functions as a recommendation unit for displaying an operation determined by the operation determination model or outputting a voice message. This allows the operator to perform appropriate operations in consideration of recommendations by the operation determination model.

[Modification of the Learning Device]

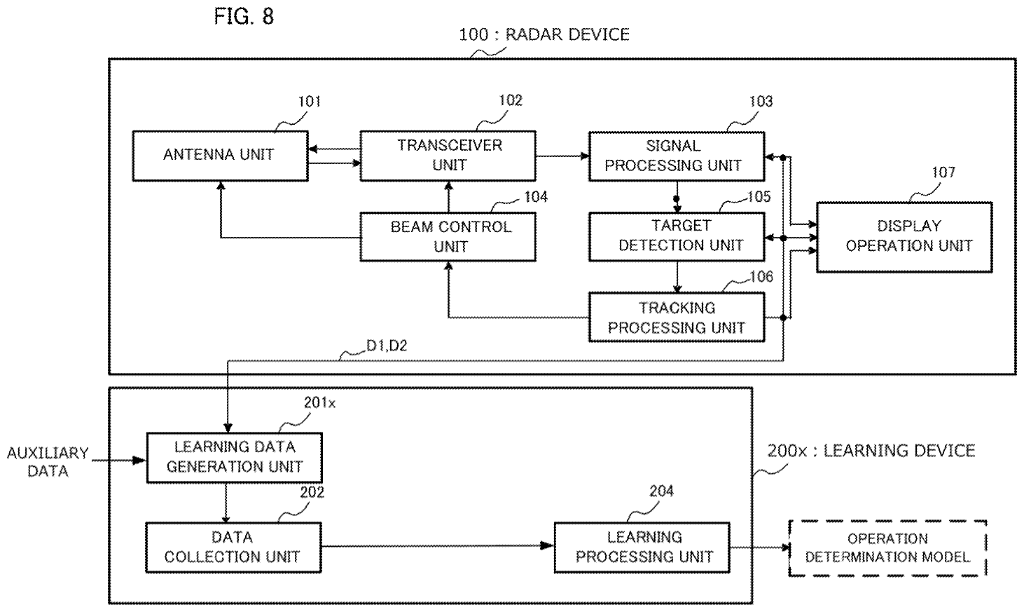

FIG. 8 is a block diagram illustrating a configuration of a modification of the learning device. The learning device 200x according to the modification includes a learning data generation unit 201x, a data collection unit 202, and a learning processing unit 204. In addition to acquiring the judgment material data D1 and the operation history data D2 from the radar device 100, the learning data generation unit 201x acquires auxiliary data from the outside. Then, the learning data generation unit 201x generates learning data additionally using the auxiliary data. Specifically, the learning data generation unit 201x includes the auxiliary data into the input data and generates the learning data. For example, the learning data generation unit 201x generates the learning data in which the reception signal and the plots serving as the judgment material data D1 and the auxiliary data are used as the input data, and the threshold value to be inputted to the target detection unit 105 is used as a teacher label.

Similar to the judgement material data D1, the auxiliary data is the data used as a material for determining whether or not an operator performs various operations, and includes the followings:

(A) Weather Information

Weather information such as weather and atmospheric pressure may affect clutter, beam trajectory, etc. Also, the SNR level of the reception signal may be affected by the reflection of the beam by clouds or the like. Therefore, it is effective to use weather information as the auxiliary data.

(B) Topographic Information

Since the reflection of the beams by mountains or the like can be a factor of clutter, it is effective to use topographic information as the auxiliary data.

(C) Radio Wave Environment Since the SNR of the reception signals and the clutter are affected by the radio wave environment, it is effective to use the radio wave environment as the auxiliary data.

(D) Airspace Usage Information

Information of airways in which passenger aircrafts fly, information of planned use of a predetermined airspace, and information of the past flight route of the unknown aircraft are useful in judging whether the target is a friendly aircraft or an unknown aircraft.

Although it is effective to learn the operation determination model using the auxiliary data in addition to the judgement material data D1 as described above, it is not ensured that all the auxiliary data used at the time of learning are obtained when the operation is actually performed using the operation determination model. For example, it is assumed that that the operation determination model has been generated using weather information and radio wave environment as the auxiliary data in addition to the judgement material data D1. In this case, if the data of radio wave environment cannot be obtained when performing automatic operation actually using the operation determination model, the learned operation determination model cannot be used as it is. In such a case, it is effective to create and use multiple models corresponding to the combinations of different input data by distillation learning. In the above example, a student model using the judgement material data D1 and the weather information as the input data can be generated by distillation learning using the operation determination model learned using the judgement material data D1, the weather information, and the radio wave environment as the teacher labels. This makes it possible to perform automatic operations even in situations where the same input data as the operation determination model created by machine learning cannot be obtained.

[Efficient Data Collection by Radar Device]

It is difficult to collect the learning data necessary for learning of the target detection model for rarely occurring situations. Therefore, the radar device 100 performs beam control for collection of learning data during the beam schedule. Particularly, if the pre-specified condition is satisfied, the radar device 100 performs the beam control intensively. The content of the beam control is changed to match the data to be collected.

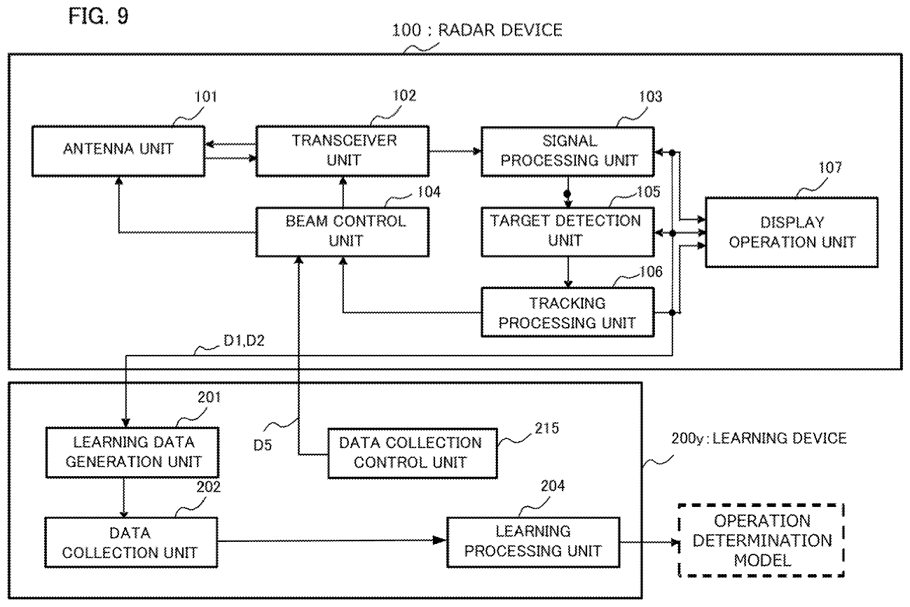

FIG. 9 shows a configuration to perform the beam control for collection of learning data. The radar device 100 has the same configuration as in FIG. 3. Meanwhile, the learning device 200y includes a data collection control unit 215 in addition to the configuration shown in FIG. 3. The data collection control unit 215 stores a condition in which the learning data is insufficient, and outputs a data collection request D5 including the condition of the data to be collected to the beam control unit 104 of the radar device 100. During the beam schedule, the beam control unit 104 controls the antenna unit 101 to emit a beam under the condition indicated by the data collection request D5. The radar device 100 constantly monitors all directions by the scan beam and tracks the target by the tracking beam when the target is detected. Therefore, the beam control unit 104 can emit a beam for collecting learning data, when a target is not detected or when there is no need to track the target, for example. The reflected wave corresponding to the emitted beam is received by the antenna unit 101, and the reception signal is outputted to the learning data generation unit 201 through the transceiver unit 102 and the signal processing unit 103. Thus, the learning device 200y can collect data corresponding to the condition in which data is insufficient.

[Application of Learned Model]

(On-Line Learning)

When the learned target detection model (hereinafter, simply referred to as a “learned model”) generated by the learning device 200 is actually applied to the radar device 100, the operation of the radar device 100 needs to be stopped because rewriting the program or the like occurs. However, the radar device performing important monitoring cannot be stopped. Therefore, the learned model cannot be applied, and the on-line learning is difficult.

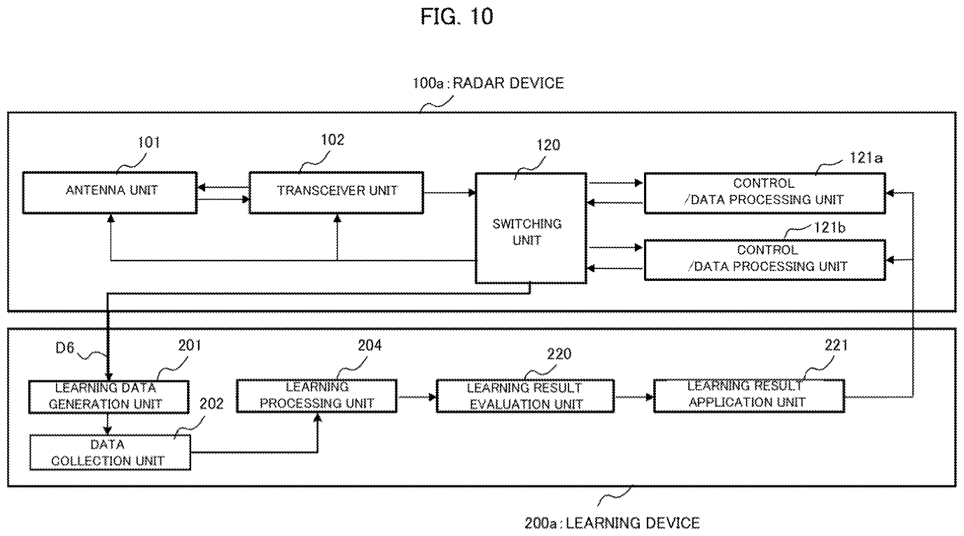

In this view, the control/data processing unit of the radar device is doubled in advance. FIG. 10 shows a configuration of a radar device and a learning device for performing on-line learning. As illustrated, the radar device 100a includes an antenna unit 101, a transceiver unit 102, a switching unit 120, and two control/data processing units 121a and 121b. The control/data processing units 121a and 121b are units including a signal processing unit 103, a beam control unit 104, a target detection unit 105, a tracking processing unit 106, and a display operation unit 107 of the radar device shown in FIG. 1. The switching unit 120 selectively connects one of the control/data processing units 121a and 121b to the antenna unit 101 and the transceiver unit 102. In addition, the switching unit 120 outputs the data D6 including the reception signals, the plots, the track, and the like to the learning data generation unit 201 of the learning device 200a from the control/data processing unit 121a or 121b in operation.

The learning device 200a includes a learning result evaluation unit 220 and a learning result application unit 221 in addition to the learning data generation unit 201, the data collection unit 202, and the learning processing unit 204. The learning result evaluation unit 220 evaluates the learned model generated by the learning processing unit 204, and outputs the learned model determined to be applicable to the radar device 100a to the learning result application unit 221. The learning result application unit 221 applies the learned model determined to be applicable to the control/data processing units 121a and 121b.

It is now assumed that the control/data processing unit 121a is in the active state, i.e., during the actual monitoring operation, and the control/data processing unit 121b is in the standby state. Namely, the switching unit 120 is connecting the control/data processing unit 121a to the antenna unit 101 and the transceiver unit 102. In this case, the learning device 200a learns the operation determination model using the data D6 outputted from the control/data processing unit 121a in the active state. During this time, the learning result applying unit 221 applies the learned model determined to be applicable to the control/data processing unit 121b in the standby state and rewrites the program.

Next, the switching unit 120 sets the control/data processing unit 121b to the active state, sets the control/data processing unit 121a to the standby state, and applies a new learned model to the control/data processing unit 121a in the standby state. In this way, it is possible to learn the operation determination model while continuing the monitoring operation on one of the control/data processing units 121a and 121b and apply the learned model to the other of the control/data processing units 121a and 121b. Namely, it becomes possible to apply the learned model and to carry out the on-line learning.

(Evaluating Model Validity)

In the on-line learning, it is difficult to judge how much the learning should be made to ensure the appropriate radar function, i.e., the validity. Further, there is a fear that the display operation unit to which the learned model is applied may operate in an unexpected manner, e.g., it performs an operation that the operator does not perform in the conventional processing, and recovery at that time is required. Therefore, the validity of the learned model is judged by operating the control/data processing unit to which the learned model is applied and the control/data processing unit in which the conventional processing is performed in parallel and comparing the processing results of them.

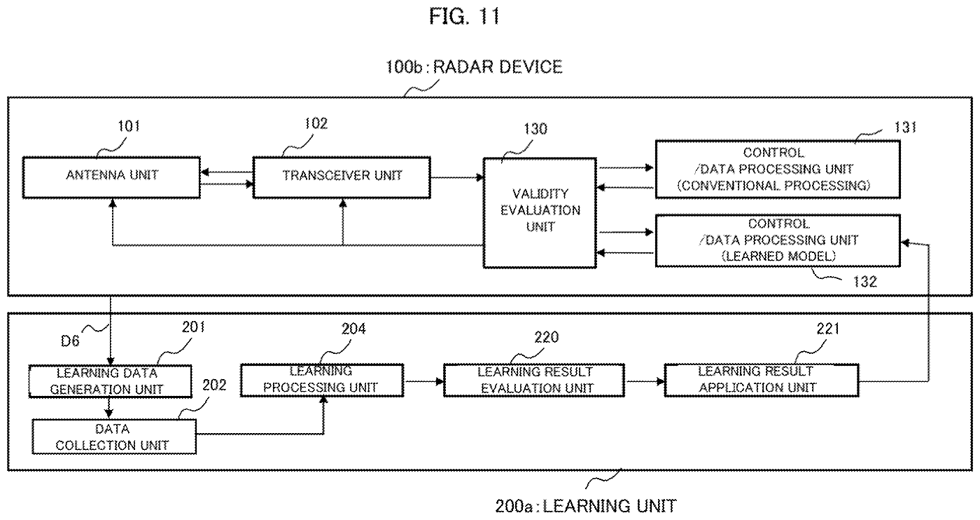

FIG. 11 shows a configuration of a radar device and a learning device for performing validity evaluation of the learned model. As shown, the radar device 100b includes an antenna unit 101, a transceiver unit 102, a validity evaluation unit 130, and two control/data processing units 131 and 132. The control/data processing unit 131 performs the conventional processing, and the control/data processing unit 132 performs processing using the learned model. The control/data processing units 131 and 132 include a signal processing unit 103, a beam control unit 104, a target detection unit 105, a tracking processing unit 106, and a display operation unit 107 of the radar device shown in FIG. 1. The learning device 200a is the same as that shown in FIG. 10.

The validity evaluation unit 130 compares the processing result of the conventional processing performed by the control/data processing unit 131 with the processing result of the learned model performed by the control/data processing unit 132 to determine the validity of the processing result of the learned model. When it is determined that the processing result of the learned model is not appropriate, the validity evaluation unit 130 outputs the processing result of the conventional processing to the antenna unit 101 and the transceiver unit 102. On the other hand, when it is determined that the processing result of the learned model is appropriate, the validity evaluation unit 130 outputs the processing result of the learned model to the antenna unit 101 and the transceiver unit 102. Even when it is determined that the processing result of the learned model is appropriate, the validity evaluation unit 130 may interpolate the processing result of the learned model with the processing result of the conventional processing to prevent an unexpected operation from occurring. Further, the validity evaluation unit 130 may be generated using machine learning or the like. Further, it is not necessary that the processing of the validity evaluation unit 130 is fully automatic, and the operator may be interposed. For example, the operator may determine the validity of the processing result of the learned model based on the information displayed on the display operation unit 107.

(Suppressing Operational Fluctuation in Using the Learned Model)

When the learned model is applied to the target detection unit, the operation of the radar device 100 may change significantly. Therefore, the control/data processing unit of the radar device 100 is doubled in advance, the learned model is applied with intentionally shifting the time of applying the learned model, and the results of the processing of the two control/data processing units are integrated to be adopted as a formal processing result.

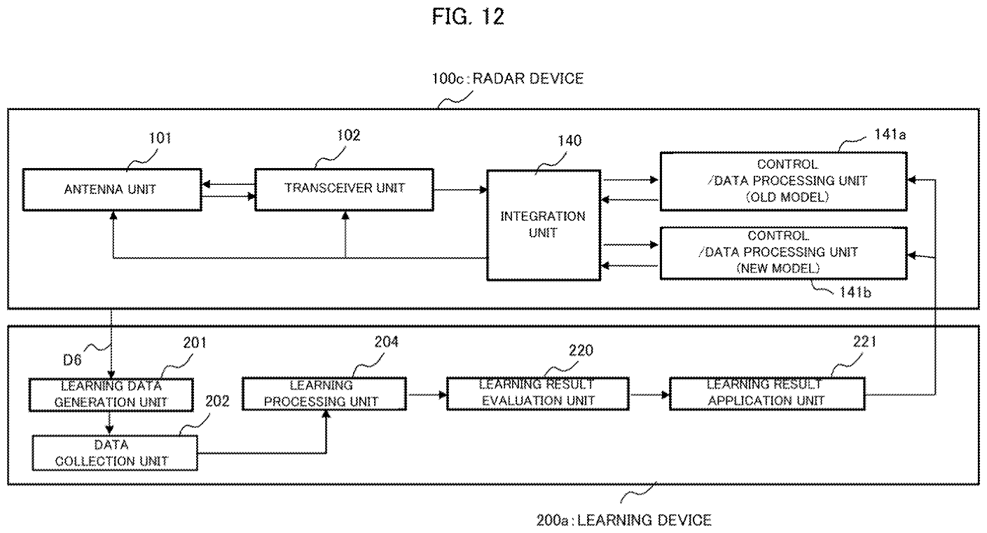

FIG. 12 shows a configuration of a radar device and a learning device for suppressing operational fluctuation by the learned model. As illustrated, the radar device 100c includes an antenna unit 101, a transceiver unit 102, an integration unit 140, and two control/data processing units 141a and 141b. The control/data processing unit 141a uses the old model, and the control/data processing unit 141b uses the new model to perform processing. The control/data processing units 141a and 141b are units including the signal processing unit 103, the beam control unit 104, the target detection unit 105, the tracking processing unit 106, and the display operation unit 107 of the radar device shown in FIG. 1. The learning device 200a is the same as that shown in FIG. 10.

The integration unit 140 integrates the processing results of the control/data processing units 141a and 141b and employs the integrated result as a formal processing result. For example, the integrating unit 140 adds the processing results from the control/data processing units 141a and 141b, divides the result of the addition by 2, and employs the result as the processing result. Thus, it becomes possible to suppress that the operation of the radar device fluctuates greatly when a new learned model is applied.

### Second Example Embodiment

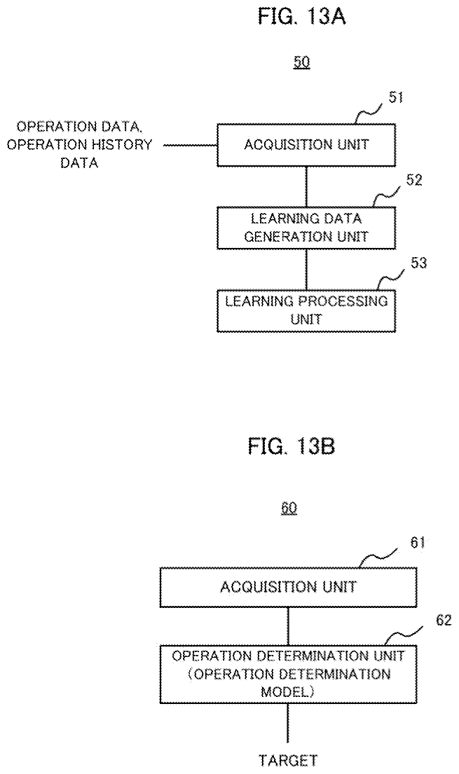

FIG. 13A is a block diagram illustrating a functional configuration of a learning device according to a second example embodiment. The learning device 50 according to the second example embodiment includes an acquisition unit 51, a learning data generation unit 52, and a learning processing unit 53. The acquisition unit 51 acquires, from a radar device, operation data generated during an operation of the radar device and operation history data indicating operations performed by an operator on the radar device. The learning data generation unit 52 generates learning data using the operation data and the operation history data. The learning processing unit 53 learns, using the learning data, an operation determination model that determines an operation to be performed on the radar device based on the operation data.

FIG. 13B is a block diagram illustrating a functional configuration of a radar device according to a second example embodiment. The radar device 60 includes an acquisition unit 61 and an operation determination unit 62. The acquisition unit 61 acquires operation data generated during an operation. The operation determination unit 62 determines an operation to be performed on the radar device based on the operation data acquired by the acquisition unit 61 using a learned operation determination model. The learned operation determination model is learned using the operation data and operation history data indicating operations performed by an operator on the radar device.

A part or all of the example embodiments described above may also be described as the following supplementary notes, but not limited thereto.

(Supplementary Note 1)

A learning device comprising:

an acquisition unit configured to acquire, from a radar device, operation data generated during an operation of the radar device and operation history data indicating operations performed by an operator on the radar device;

a learning data generation unit configured to generate learning data using the operation data and the operation history data; and

a learning processing unit configured to learn, using the learning data, an operation determination model which determines an operation to be performed on the radar device based on the operation data.

(Supplementary Note 2)

The learning device according to Supplementary note 1, wherein, for an operation included in the operation history data, the learning data generation unit generates the learning data in which the operation data acquired when the operation is performed is used as input data and the operation is used as a teacher label.

(Supplementary Note 3)

The learning device according to Supplementary note 1 or 2, wherein the operation data includes at least one of a reception signal by the radar device, a plot of a target detected based on the reception signal, and a track of the target.

(Supplementary Note 4)

The learning device according to any one of Supplementary notes 1 to 3, further comprising an auxiliary data acquisition unit configured to acquire auxiliary data,

wherein the learning data generation unit generates the learning data additionally using the auxiliary data.

(Supplementary Note 5)

The learning device according to Supplementary note 4, wherein the auxiliary data includes at least one of weather information, topographical information, radio wave environment information, and airspace usage information.

(Supplementary Note 6) The learning device according to any one of Supplementary notes 1 to 5, wherein the operation is to set a clutter area in a reception signal by the radar device.

(Supplementary Note 7)

The learning device according to any one of Supplementary notes 1 to 5, wherein the operation is to adjust a threshold value used in detecting a target based on a reception signal by the radar device.

(Supplementary Note 8)

The learning device according to any one of Supplementary notes 1 to 5, wherein the operation is to create a track of a target detected by the radar device and instruct tracking.

(Supplementary Note 9)

A learning method comprising: acquiring, from a radar device, operation data generated during an operation of the radar device and operation history data indicating operations performed by an operator on the radar device;

generating learning data using the operation data and the operation history data; and

learning, using the learning data, an operation determination model which determines an operation to be performed on the radar device based on the operation data.

(Supplementary Note 10)

A recording medium recording a program, the program causing a computer to execute processing of:

acquiring, from a radar device, operation data generated during an operation of the radar device and operation history data indicating operations performed by an operator on the radar device;

generating learning data using the operation data and the operation history data; and

learning, using the learning data, an operation determination model which determines an operation to be performed on the radar device based on the operation data.

(Supplementary Note 11)

A radar device comprising:

an acquisition unit configured to acquire operation data generated during an operation; and

an operation determination unit configured to determine an operation to be performed on the radar device based on the operation data acquired by the acquisition unit using a learned operation determination model, the learned operation determination model being learned using the operation data and operation history data indicating operations performed by an operator on the radar device.

(Supplementary Note 12)

The radar device according to Supplementary note 11, further comprising an automatic operation unit configured to automatically execute an operation determined by the operation determination unit.

(Supplementary Note 13)

The radar device according to Supplementary note 11, further comprising a recommendation unit configured to recommend the operation determined by the operation determination unit.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

100 Radar device

101 Antenna unit

102 Transceiver unit

103 Signal processing unit

104 Beam control unit

105 Target detection unit

106 Tracking processing unit

107 Display operation unit

110 Demodulation processing unit

111 Coherent integration unit

114 Display operation unit

200 Learning device

201 Learning data generation unit

202 Data collection unit

204 Learning processing unit

What is claimed is:

1. A learning device comprising:
a memory configured to store instructions; and
one or more processors configured to execute the instructions to:
acquire, from a radar device, operation data generated during an operation of the radar device and operation history data indicating operations performed by an operator on the radar device;
generate learning data using the operation data and the operation history data; and
learn, using the learning data, an operation determination model which determines an operation to be performed on the radar device based on the operation data.

2. The learning device according to claim 1, wherein, for an operation included in the operation history data, the one or more processors generate the learning data in which the operation data acquired when the operation is performed is used as input data and the operation is used as a teacher label.

3. The learning device according to claim 1, wherein the operation data includes at least one of a reception signal by the radar device, a plot of a target detected based on the reception signal, and a track of the target.

4. The learning device according to claim 1, wherein the one or more processors are further configured to acquire auxiliary data,
wherein the one or more processors generate the learning data additionally using the auxiliary data.

5. The learning device according to claim 4, wherein the auxiliary data includes at least one of weather information, topographical information, radio wave environment information, and airspace usage information.

6. The learning device according to claim 1, wherein the operation is to set a clutter area in a reception signal by the radar device.

7. The learning device according to claim 1, wherein the operation is to adjust a threshold value used in detecting a target based on a reception signal by the radar device.

8. The learning device according to claim 1, wherein the operation is to create a track of a target detected by the radar device and instruct tracking.

9. A learning method comprising:
acquiring, from a radar device, operation data generated during an operation of the radar device and operation history data indicating operations performed by an operator on the radar device;
generating learning data using the operation data and the operation history data; and
learning, using the learning data, an operation determination model which determines an operation to be performed on the radar device based on the operation data.

10. A recording medium recording a program, the program causing a computer to execute the learning method according to claim 9.

11. A radar device comprising:
a memory configured to store instructions; and
one or more processors configured to execute the instructions to:
acquire operation data generated during an operation; and
determine an operation to be performed on the radar device based on the operation data acquired by the acquisition unit using a learned operation determination model, the learned operation determination model being learned using the operation data and operation history data indicating operations performed by an operator on the radar device.

12. The radar device according to claim 11, wherein the one or more processors are further configured to automatically execute an operation determined by the operation determination unit.

13. The radar device according to claim 11, wherein the one or more processors are further configured to recommend the operation determined by the operation determination unit.
